(19) United States
(12) Patent Application Publication
(10) Pub. No.: US 2006/0086457 A1
(43) Pub. Date: Apr. 27, 2006

(54) Method of producing resin joint boot

(75) Inventors: Takenori Ohshita, Osaka (JP); Eiichi Imazu, Osaka (JP); Takeshi Ueda, Osaka (JP); Katsushi Saito, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Toyo Tire & Rubber Co., Ltd., Osaka (JP)

(21) Appl. No.: 10/527,815

(22) PCT Filed: Jun. 9, 2004
(86) PCT No.: PCT/JP04/08421

§ 371 Date: Mar. 14, 2005

(51) Int. Cl. B32B 37/00; H05B 6/00

(52) U.S. Cl. 156/272.8; 264/482

(57) ABSTRACT

A method of manufacturing a resin-made joint boot (10) provided with a boot body (12) including a large-diameter tubular part (14), a small-diameter tubular part (16) and a bellows section (18), and a bushing (30) fitted inside the large-diameter tubular part, wherein the boot body and the bushing are separately molded, the bushing is positioned inside the large-diameter tubular part of the boot body, and then, both are integrally fastened by laser welding. The large-diameter tubular part (14) is provided on its internal periphery with an outwardly divergent tilting surface (24) while the bushing (30) is provided with an annular projecting portion (42) to be abuttingly disposed on the tilting surface, and laser (R) is irradiated, penetrating through the annular projecting portion (42) onto the tilting surface (24).

### TECHNICAL FIELD

This invention relates to a resin-made joint boot in a bellows form, for example, used for covering parts of shafts of an automotive constant velocity joint, and more particularly to the production of the resin-made joint boot suitable for a tripod type joint part adopted for constant velocity joints for automotive drive shafts or the like.

### BACKGROUND ART

A constant velocity joint of this tripod type comprises, as shown in FIGS. 6 and 7, a tripod member 4 constructed so that three trunnions 3 each supporting and bearing rotatably a roller 2 protrude in a normal direction to the axis of the one shaft 1 of an input shaft and an output shaft, and an outer casing 6 connected to an end of the other shaft 5. The outer casing 6 is provided on its inner periphery with three axially extending slide grooves 6a that correspond to the three rollers 2 of the tripod member 4. The constant velocity joint is constructed so that the three rollers 2 of the tripod member 4 are fitted in the respective slide grooves 6a so as to be axially slidable, whereby the running torque can be transmitted while making relatively variable the intersecting angle of center axes of both shafts 1, 5.

In the constant velocity joint thus constructed, in order to prevent dust or extraneous matter from entering inside the joint or to keep the sealed grease therein without leakage, a bellows-shaped resin-made joint boot 100 that is expansible and deformable to flexure is, in general, installed in a manner covering from the outer casing 6 to part of the shaft 1 on the tripod member 4 side.

The joint boot 100 is configured at its one axial end as a large-diameter attachment part 102, which is fitted to an external periphery of the outer casing 6 and fixed with a ring-like damping member 7 and at its other axial end as a small-diameter attachment part 103, which is fixed on an external periphery of the shaft 1 on the tripod 4 side with a ring-like damping member 8, both being integrally connected through a bellows part 101. The outer casing 6 has an external peripheral contour assuming a circumferentially salient and reentrant (concave and convex) shape corresponding to the geometry of the slide grooves 6a on the internal periphery thereof as illustrated in FIG. 7 and hence, the large-diameter attachment part 102 assumes a non-circular configuration corresponding to the external peripheral contour of the outer casing 6. That is, the large-diameter attachment part 102 is configured on its internal periphery with inwardly protruding convex portions 104 at three circumferential locations corresponding to concave portions 6b of the outer casing 6.

A joint boot having such a large-diameter attachment part that is integrally provided with the above-mentioned convex portions is proposed in JP patent application No. 2003-329057 A. Here, to form a plurality of the convex portions, it is necessary to configure such a complicated cylindrical attachment part that thick-walled parts and thin-walled parts are circumferentially alternated integrally with a bellows section by injection blow molding or the like. To that end, a special mold must be used, which fact is likely to lead to an increase in production cost. Further, sink marks are prone to be produced owing to shrinkage of the resin after molding, which may be responsible for impairing the sealing capability when mounted on the outer casing. In order to dissolve such problem of sink marks, an extremely high molding precision and an improvement in configuration of the convex portions will be required, which will bring on a further rise in production cost.

European patent application No. 924450 (EP09244502A2) discloses the technology of molding a bushing with convex portions as stated above separately from a boot body, disposing the bushing on a circular inner periphery of a large-diameter tubular part of the boot body, and then joining both integrally with each other by spin welding. The spin welding is, however, to weld the resin by heating and fusing the resin with friction heat generated by spinning and hence it takes an excessive time to weld, resulting in a rise in production cost.

### DISCLOSURE OF INVENTION

In order to eliminate the problems as stated above thereby to obtain a resin-made joint boot having a superior sealing capability against the outer casing while suppressing a rise in fabrication cost, it is advantageous to mold the aforesaid bushing with the convex portions separately from the boot body and then to secure the both integrally by laser welding. However, since the bushing has the convex portions on the internal peripheral part as mentioned above, upon irradiation of laser beam if the laser radiation is directed radially outwardly from a center position of the bushing, a difference in optical path lengths of laser transmitted through the resin material portion of the bushing is created between a location with the convex portions and a location without them, as a result of which it is unable to conduct the laser irradiation with a circumferentially even energy. For this reason, it is required to irradiate laser R obliquely from upwardly of a center axis (tube axis line) axially spaced apart from an open edge 110a of a large-diameter tubular part 110 of the boot body as shown in FIG. 8. In that case, the irradiation angle beta (β) at which the laser R is irradiated through the bushing 112 to an inner peripheral surface 110b of the large-diameter tubular part 110 will be not perpendicular, but oblique. When irradiated obliquely, the laser R is reflected on the inner peripheral surface 110b of the large-diameter tubular part 110 as a welding surface and the energy of the laser R absorbed on the inner peripheral surface 110b is diminished such that an incomplete welding occurs or to avoid it, the laser intensity is necessitated to be raised.

In view of the actual situation as described above, this invention has been made, and it is an object of this invention to provide a method of manufacturing a resin-made joint boot having a remarkable sealing capability between it and an outer casing and capable of ensuring a sufficient durability while suppressing a rise in fabrication cost.

In order to achieve the foregoing object, the manufacturing method of a resin-made joint boot pertaining to this invention includes the following steps of

a step of molding a boot body from a laser energy absorbing thermoplastic resin material, the boot body comprising a large-diameter tubular part at an axially one end thereof, a small-diameter tubular part at the other end, and a bellows part interconnecting the both, the large-diameter tubular part having, on an internal peripheral surface of its open end, an outwardly diverging tilting surface;

a step of molding a bushing to be fitted inside the large-diameter tubular part from a laser energy transmitting resin material, the bushing comprising an external peripheral wall in a circular form in cross-section engaging with the internal peripheral surface of the aforesaid large-diameter tubular part and an internal peripheral wall having inwardly protruding convex portions at a plurality of circumferential places, and having, at its axial end to be disposed to the open end of the aforesaid large-diameter tubular part, an annular projecting portion to be abuttingly disposed on the tilting surface;

and a step of disposing the bushing inside the large-diameter tubular part of the boot body, transmitting laser through the annular projecting portion of the bushing to irradiate it on the tilting surface of the boot body thereby heating and fusing abutment parts of the annular projecting portion and the tilting surface to weld them, thus rendering the boot body and the bushing integral with each other.

According to this invention thus constituted, because of the fact that the bushing having on its internal periphery the convex portions to be received in a plurality of the concave portions on the external periphery of the outer casing is molded separately from the boot body and after molding, both are integrated by laser welding, the invention method dispenses with the use of a special mold for molding of both as compared to the case where both are integrally molded from the outset, although the number of the production steps is increased; the time required for laser welding is shorter than the molding cycle time in the case of integral molding; the production of sinks ascribed to shrinkage after molding is very low and hence, a high molding precision and any configurational improvement for coping with the production of sinks are not required. Taken altogether, these enable the overall production cost to be reduced and a good sealing capability between the bushing and the outer casing to be ensured.

Further because the boot body and the bushing are integrally joined together by laser welding, it is possible to ensure sufficiently the durability of the overall joint boot made of resin while holding an equal integrity to an integrally molded product of both, without the bushing being disengaged or being loose when the joint boot is installed and used.

Again because the outwardly diverging tilting surface is provided on the internal peripheral face of the boot body while the bushing is provided with the annular projecting portion to be abuttingly disposed on the tilting surface, and laser beam is irradiated penetrating through the annular projecting portion onto the tilting surface, the laser irradiation angle to the biting surface, when laser beam is irradiated obliquely from above the center axis (tuber axis line) at the location axially spaced apart from the boot body, can be made perpendicular or nearly perpendicular. As a consequence, an efficient laser welding can be conducted in spite of the fact that the bushing has on its internal periphery the convex portions. Stated another way, it is possible to ensure good welding performance while minimizing the intensity of laser beam to suppress an increase in consumption power as far as possible.

In the manufacturing method of this invention, the aforesaid annular projecting portion is provided with a welding surface to be abuttingly disposed on the biting surface and a laser incidence surface on which laser is incident, and the thickness of the annular projecting portion defined by the distance between the welding surface and the incident surface is preferred to be constant. In this manner the thickness of the annular projecting portion through which laser penetrates is made constant, whereby it is possible to make the optical path length of the laser beam penetrating through the annular projecting portion constant, even if the laser irradiating position is deviated owing to an error caused when the boot body is installed on a laser irradiation equipment, thus avoiding an incomplete welding.

In the manufacturing method of the invention, furthermore, it is preferred to irradiate laser virtually perpendicularly (more particularly, in the range of 90±10 degrees) on the tilting surface of the boot body, whereby an efficient laser welding can be performed.

### BRIEF DESCRIPTION OF THE DRAWINGS

FIG. 1 is a half longitudinally sectional side elevation of a resin-made joint boot relating to one embodiment of this invention;

FIG. 2 is a front elevation of the aforesaid resin-made joint boot when viewed from its large-diameter tubular part;

FIG. 3 is a schematic illustration showing a laser welding step of a boot body and a bushing of the resin-made joint boot;

FIG. 4 is an enlarged sectional view of essential parts of the boot body and the bushing upon laser welding relating to the embodiment;

FIG. 5 is an enlarged sectional view of essential parts of the boot body and the bushing upon laser welding relating to another embodiment;

FIG. 6 is a longitudinally sectional side elevation showing a tripod type constant velocity joint equipped with a conventional resin-made joint boot;

FIG. 7 is a front elevation of the constant velocity joint in FIG. 6;

FIG. 8 is an enlarged sectional view showing essential parts of a boot body and a bushing relating to a comparative example upon laser welding.

### BEST MODE FOR CARRYING OUT THE INVENTION

Embodiments for carrying out the invention will be hereinafter described with reference to the accompanying drawings.

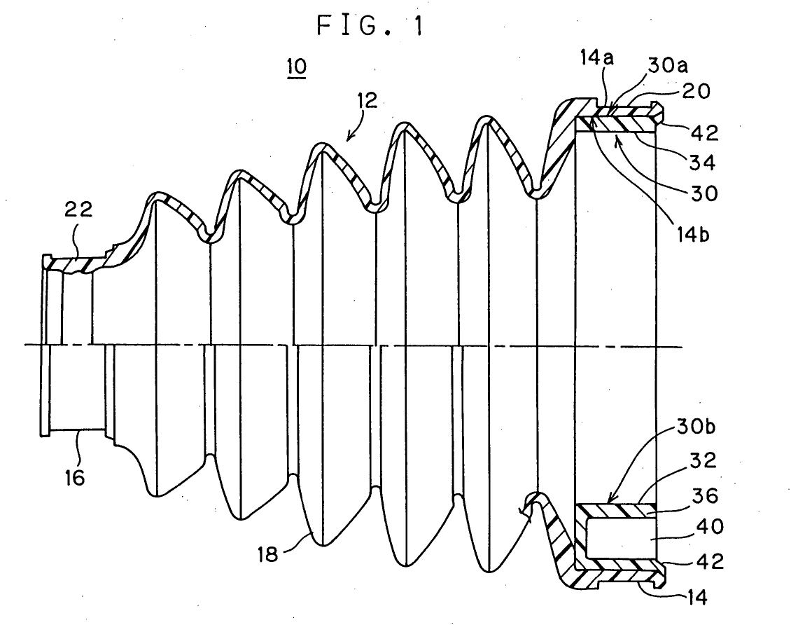

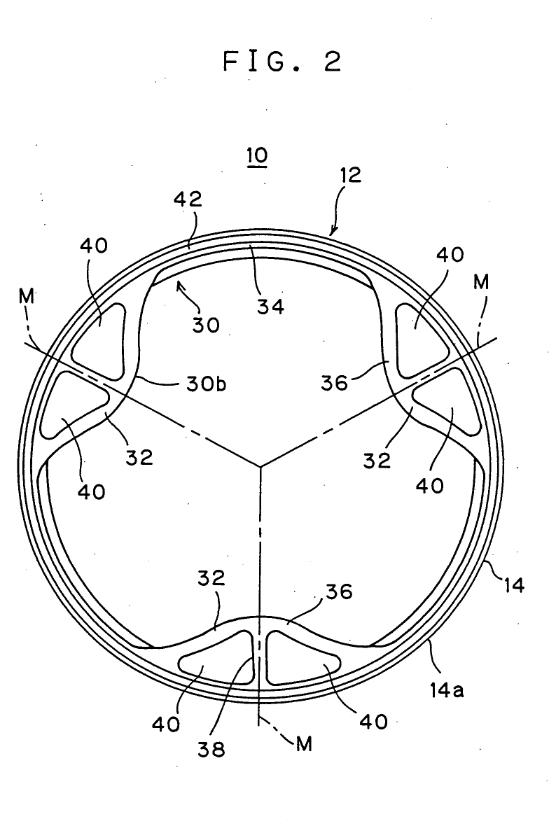

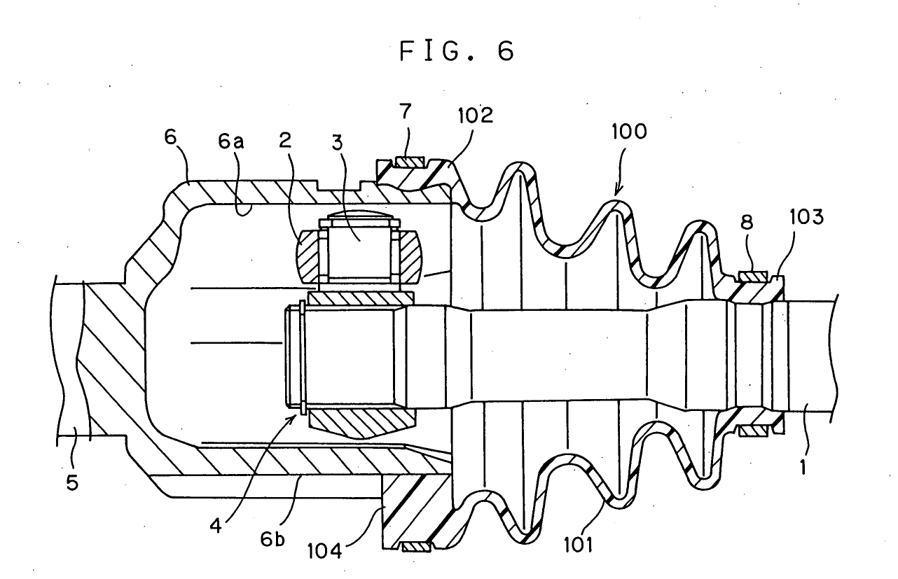

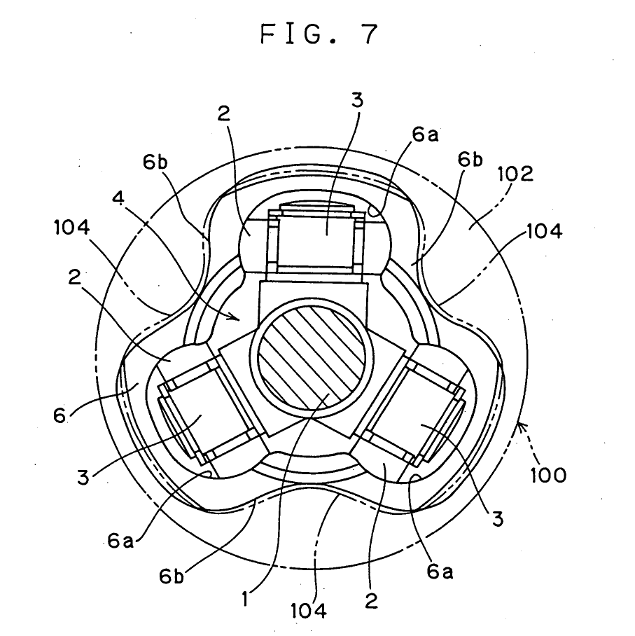

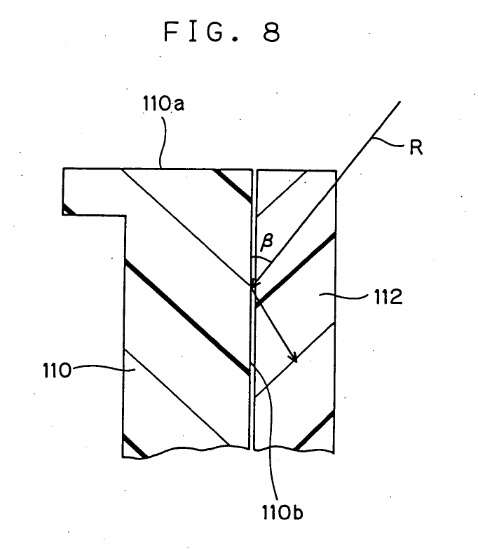

A resin-made joint boot 10 relating to this embodiment as shown in FIGS. 1 and 2 is destined to be installed on a tripod type of constant velocity joint for automobiles illustrated in FIGS. 6 and 7 and comprises a boot body 12 and a bushing 30 integrally joined.

The boot body 12 includes a large-diameter tubular part 14 on an axially one end side, a small-diameter tubular part 16 on the other end side disposed coaxially in a spaced relation to the large-diameter tubular part 14, and a bellows part 18 interconnecting the large-diameter tubular part 14 and the small-diameter tubular part 16. The large-diameter tubular part 14 assumes the form of a short cylinder to be externally fitted and secured on an outer casing 6, with the bushing 30 interposed as an insert material and is provided, on its external peripheral surface, with a circumferentially extending recessed portion 20 for fixation for receiving thereon a ring-form damping member 7 (cf. FIG. 6). The small-diameter tubular part 16 assumes the form of a short cylinder to be externally fitted and fixed to a shaft 1 on the tripod 4 side and is provided, on its external peripheral surface, with a circumferentially extending recessed portion 22 for fixation for receiving a ring-like damping member 8 (cf. FIG. 6). The bellows section 18 is of a bellows body in a circular form in cross-section having a bore diameter difference at both ends and formed to be gradually tapered down from the large-diameter tubular part 14 to the small-diameter tubular part 16, forming internally a grease-enclosed space.

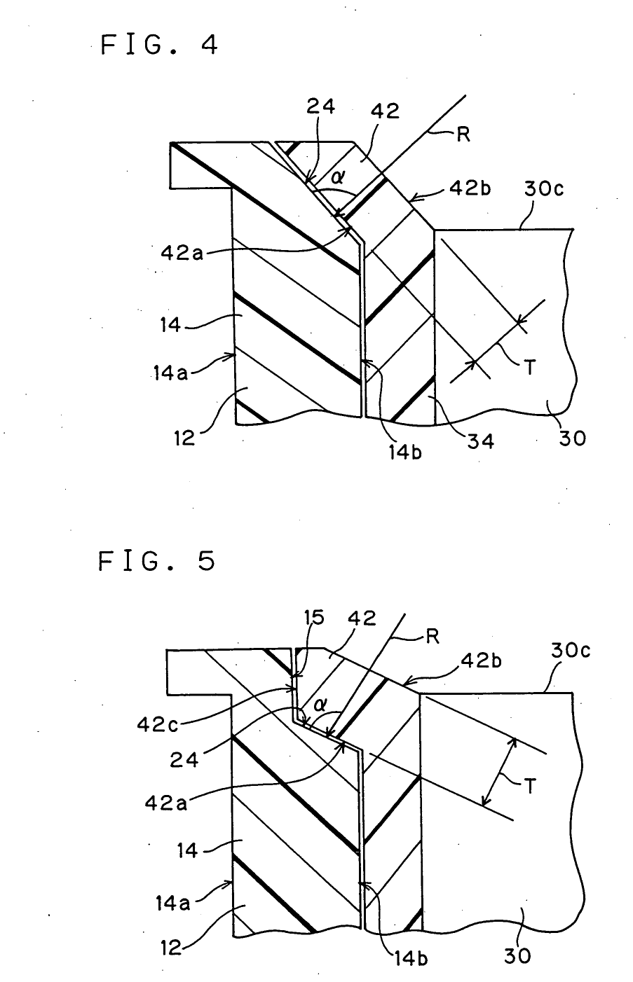

As shown in FIGS. 1 and 2, the large-diameter tubular part 14 assumes a circular form in cross-section on its both external peripheral surface 14a and internal peripheral surface 14b. On the internal peripheral surface 14b of the large-diameter tubular part 14 at its open end, as shown in an enlarged view of FIG. 4, there is further formed an outwardly divergent tilting face 24. More particularly, the internal peripheral surface 14b of the large-diameter tubular part 14 is formed in an inverse taper form such that the more axially outward side at the open end is more divergent radially outwardly, whereby the tilting surface 24 tilting relative to the tube axis line is formed over a whole circumference of the open end.

The bushing 30 is to be fitted inside the large-diameter tubular part 14 of the boot body 12. It has an external peripheral wall 30a in a circular form in cross-section engaging with the internal peripheral surface 14b of the large-diameter tubular part 14, and an internal peripheral wall 30b having convex portions 32 formed in a manner bulging in the form of an inwardly curved face at three circumferential places thereof so as to correspond to the external peripheral contour of the outer casing 6, which has three circumferential concave portions 6b disposed equidistantly. The bushing 30 in this embodiment is to abut on the internal peripheral surface 14b of the large-diameter tubular part 14 and comprises tubular portions 34 having a substantially constant wall thickness, inside wall portions 36 bulging inwardly from the internal peripheral surface of the tubular portion 34 to form the convex portions 32, and support wall portions 38 each interconnecting, at a circumferentially center of the internal wall portion 36, the internal wall portion 36 and the tubular portion 34 outside it. Thereby each of the convex portions 32 forms two cavities 40, 40 disposed bilaterally relative to its circumferentially middle line M, the existence of which (40, 40) restrains the creation of sinks ascribable to shrinkage after molding of the resin of the bushing 30 itself.

As depicted in FIG. 4 in an enlarged scale, the bushing 30 is formed, at its axial end to be disposed on the open end of the large-diameter tubular part 14, with an annular projecting portion 42 to be disposed to abut on the tilting surface 24, and the abutment parts of the annular projecting portion 42 and the tilting surface 24 are integrated by laser welding, which will be later described.

The annular projecting portion 42 is provided to jut over an axial edge face 30c of the bushing 30 at the axial edge of the tubular portion 34 to extend in a manner being bent radially outwardly along the tilting surface 24. The annular projecting portion 42 further has a welding surface 42a, which is disposed to abut on the tilting surface 24 and welded to the tilting surface 24 by laser beam R, and a laser incidence surface 42b on which laser beam is incident. The welding surface 42a and the incident surface 42b are formed to be parallel to each other so that a thickness T of the annular projecting portion 42 defined by the distance between the welding surface 42a and the incident surface 42b may be constant.

In manufacturing this resin-made joint boot 10, the boot body 12 having the configuration above is molded from a laser energy absorbing thermoplastic resin material compounded with carbon black or the like according to well-known molding method such as injection blow molding. On the other hand, the bushing 30 is molded separately from the boot body 12 from a laser energy transmitting thermoplastic resin material, for example, not compounded with carbon black by injection molding.

Using the boot body 12 and the bushing 30 thus molded separately, the bushing 30 is fitted concentrically in the large-diameter tubular part 14 of the boot body 12, and thereafter both are integrated by laser welding.

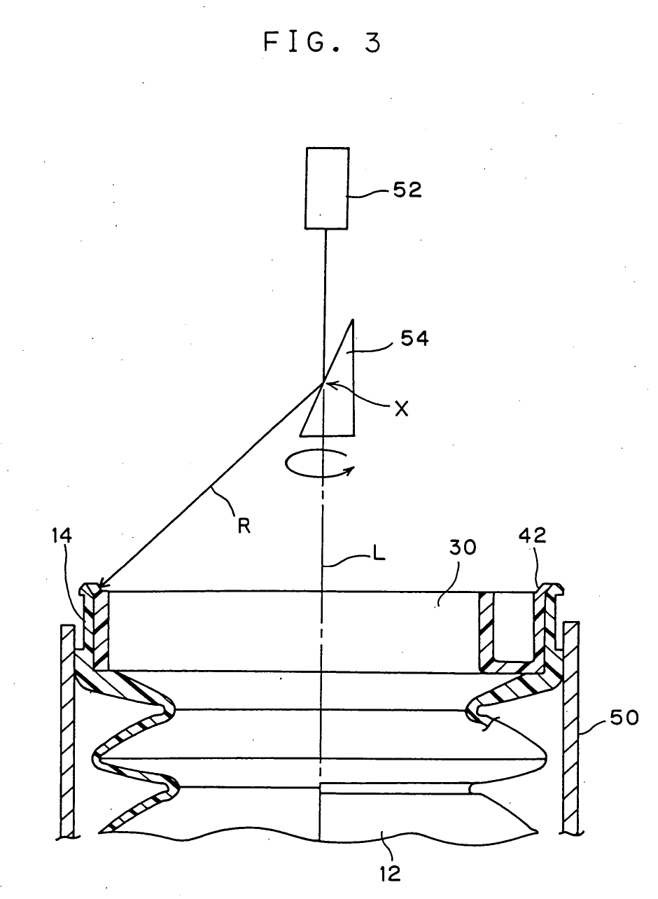

The laser welding can be carried out using a laser irradiation equipment as shown in FIG. 3. That is, the boot body 12 having the bushing 30 fitted therein is held stationary using a jig 50 with the large-diameter tubular part 14 side directed upside, and laser R is irradiated obliquely (at an inclined angle to a center axis L) from a point X above the center axis L (tube axis line) located to be spaced apart axially upwardly from the boot body 12. The laser R is emitted from a laser irradiator 52, reflected on the point X on a mirror 54 located above the center axis L, and ultimately irradiated on the annular projecting portion 42 of the bushing 30. At that time, the mirror 54 is rotated centering on the center axis L, whereby the laser R draws a conical plane-like irradiation locus and is irradiated circumferentially on the annular projecting portion 42 over its whole circumference.

Because the bushing 30 is made of a thermoplastic resin material having a laser energy transmission property, the laser R thus irradiated toward the annular projecting portion 42 penetrates through the annular projecting portion 42 to be ultimately irradiated on the tilting surface 24 of the boot body 12, as shown in FIG. 4. Then, the laser R is absorbed by the biting surface 24, because the boot body 12 is made of laser energy absorbing thermoplastic resin material, whereby the abutment parts of the annular projecting portion 42 and the tilting surface 24 are heated and fused and welded together.

Here, since this embodiment is constituted so that the tilting surface 24 is provided on the boot body 12 and the laser may be irradiated on the tilting surface 24 after transmission through the annular projecting portion 42 on the bushing 30 side, which is abuttingly disposed on the tilting surface 24, it is possible to make the irradiation angle alpha (α) of laser R irradiated from the mirror 54 to the tilting surface 24 almost perpendicular. Therefore it is possible to suppress the reflection of the laser R on the biting surface 24 to conduct an efficient laser welding.

Further it is constituted so that the bushing 30 has the inwardly protruding convex portions 32 at a plurality of circumferential places, yet is provided with the annular projecting portion 42 axially jutting over the edge surfaces of the convex portions 32, and the laser R may be irradiated on the annular projecting portion 42, and hence, it is possible to irradiate the laser R on the internal peripheral surface 14b of the large-diameter tubular part 14 without transmitting laser through the convex portions 32. Therefore it is possible to render the optical path length of the laser R penetrating through the bushing 30 constant in the circumferential direction thereby conducting laser welding with even energy in the circumferential direction.

Again because the thickness T of the annular projecting portion 42 through which laser R penetrates is constant as stated above, the optical path length of the laser R penetrating the annular projecting portion 42 can be made constant even if the irradiation position of the laser R is axially deviated due to an installation error of the boot body 12, thereby to avoid a bad welding.

FIG. 5 indicates the states of the boot body 12 and the bushing 30 upon laser welding relating to a modified example to the foregoing embodiment In this example, the tilting surface 24 is formed, on the internal peripheral surface 14b of the open end of the large-diameter tubular part 14, in a stepped form. As a consequence, outside (open edge side) the tilting surface 24 as a step portion there is further provided a parallel surface 15 to the center axis, unlike the example shown in FIG. 4. The other constitution than that is similar to the foregoing embodiment, and therefore similar effects are also achieved to the foregoing embodiment. Moreover, in this example, outside the tilting surface 24 as a welding surface there is ensured the parallel surface 15 relative to the center axis, on which the top end surface 42c of the annular projecting portion 42 is abuttingly disposed. Outside the welding surface there are ensured abutment portions of the parallel surface 15 relative to the center axis and the annular projecting portion 42 in this manner, and consequently, it is possible to suppress extraneous matter from entering into the welding part from outside and to enhance the durability of the welding part.

According to the production method in this embodiment described above, because of the fact that the bushing 30 having on its internal periphery a plurality of the convex portions 32 to be fitted in a plurality of the concave portions 6b on the external periphery of the outer casing 6 is molded separately from the boot body 12, followed by integration of both by laser welding, the number of production steps is increased yet no special mold is needed, as compared with the case of integral molding of both from the outset; the time required for laser welding is shorter than the molding cycle time with the integral molding case; sinks ascribed to shrinkage after molding are little produced, to cope with which a high molding precision and improvement in geometry are not required. These as a whole enable it to reduce the production cost and to ensure a good sealing capability against the outer casing 6.

Further because of the integral fastening of the boot body 12 and the bushing 30 by laser welding, when the joint boot 10 is mounted for use, it is possible to achieve an equal integrity to the integrally molded product of both with no danger of the bushing 30 being disengaged or becoming loose, thereby ensuring sufficiently the durability of the overall joint boot made of resin.

This invention can be utilized for the manufacture of resin-made joint boots in a bellows shape which are used to cover shaft parts of a variety of joints, typically such as automotive constant velocity joints.

1. A method of manufacturing a resin-made joint boot comprising the steps of
molding a boot body from a laser energy absorbing thermoplastic resin material,
said boot body including a large-diameter tubular part at axially one end thereof, a
small-diameter tubular part at the other end thereof, and a bellows section interconnecting both, the large-diameter tubular part having, on an internal peripheral surface thereof at its open end, an outwardly divergent tilting surface;
molding a bushing to be fitted inside the large-diameter tubular part from a laser energy transmitting thermoplastic resin material,
said bushing including an external peripheral wall of a circular form in cross-section adapted to engage with the internal peripheral surface of the large-diameter tubular part and an internal peripheral wall having inwardly protruding convex portions at a plurality of circumferential places, the bushing being provided, at its axial end to be disposed on the open end side of the large-diameter tubular part, with an annular projecting portion to be disposed to abut on the tilting surface;
and disposing the bushing inside the large-diameter tubular part of the boot body, and irradiating laser through the annular projecting portion of the bushing onto the biting surface of the boot body, thereby heating and fusing abutment parts of the annular projecting portion and the tilting surface to weld them together, whereby to integrate the boot body and the bushing.

2. The manufacturing method of a resin-made joint boot as set forth in claim 1, wherein said annular projecting portion has a welding surface to be disposed to abut on the biting surface of the boot body and a laser incidence surface on which laser is incident, and a thickness of the annular projecting portion defined by a distance between the welding surface and the laser incidence surface is constant.

3. The manufacturing method of a resin-made joint boot as set forth in claim 1 or 2, wherein laser is irradiated substantially perpendicularly on the tilting surface of the boot body.
